(19) United States
(12) Patent Application Publication
(10) Pub. No.: US 2017/0106553 A1
(43) Pub. Date: Apr. 20, 2017

(54) Cutting System

(71) Applicant: Bryan Zenner, Phoenix, OR (US)

(72) Inventor: Bryan Zenner, Phoenix, OR (US)

(21) Appl. No.: 14/883,417

(22) Filed: Oct. 14, 2015

(51) Int. Cl. B26D 5/10; B26D 7/01; B26D 1/547

(52) U.S. Cl. CPC B26D 5/10; B26D 1/547; B26D 7/01

(57) ABSTRACT

A cutting system having a cutting portion arrangeable around an exterior area of an object to cut the object is disclosed. The cutting portion may be configured to deform from a first shape having a size substantially the same as a size of the exterior of the object to a second shape having a size smaller than the size of the exterior of the object to cut the object when the cutting portion is displaced. By virtue of having a cutting portion configured to deform from a first shape to a second shape to cut an object, the cutting system can take less time to cut an object and can prevent a user from cutting portions of his or her body.

### BACKGROUND

Cutting tools exist for slicing objects. For example, knives having a blade configured to cut objects via a sawing motion or push-through motion exist. When cutting objects, proper use is required to prevent the blade of the knife from coming in contact with portions of the body and potentially cutting a portion of the body. Because proper use is required to prevent the blade of the knife from coming in contact with portions of the body, cutting objects may take longer amounts of time. For example, using a knife may require additional amounts of time to properly grip (e.g., hold) the knife and properly grip the object to prevent the blade of the knife from coming in contact with portions of the body while cutting the object.

Cutting tools exist that have a guard for a blade. For example, cutting tools may include a guard disposed over a blade to prevent portions of the body from coming in contact with the blade when cutting an object with the knife. However, the existing guards are not entirely effective. Subsequently, the existing guards do not always prevent portions of a body from coming in contact with a blade of knife.

Accordingly, there remains a need in the art for improved cutting systems that take less time to cut an object and prevent portions of a body from coming in contact with a blade of a knife.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts a front view of an illustrative cutting tool having a cutting portion arrangeable around an exterior area of an object to cut the object.

FIG. 2 illustrates the cutting portion may be configured to deform from a first shape to a second shape to cut an object.

FIG. 3 depicts a front view of an alternative implementation of the cutting tool having the cutting portion arrangeable around an exterior area of an object to cut the object.

FIG. 4 depicts a front view of another alternative implementation of the cutting tool having the cutting portion arrangeable around an exterior area of an object to cut the object.

FIG. 5 depicts a front view of another alternative implementation of the cutting tool having the cutting portion arrangeable around an exterior area of an object to cut the object.

FIG. 6 depicts a front view and a back view of another alternative implementation of the cutting tool having the cutting portion arrangeable around an exterior area of an object to cut the object.

FIG. 7 depicts a perspective view of another alternative implementation of the cutting tool having the cutting portion arrangeable around an exterior area of an object to cut the object.

FIG. 8 is a flow diagram illustrating an example process of cutting an object with a cutting tool having a cutting portion arrangeable around an exterior of the object.

### DETAILED DESCRIPTION

### Overview

This application describes cutting systems having a cutting portion arrangeable around an object to cut the object. The cutting systems may pierce an object with a piercing portion (e.g., a pick, a spike, a prong, a barb, a point, etc.), and the cutting portion may be selectively moved to deform the cutting portion around the object to cut the object while the object is retained by the piercing portion. For example, a user may force the piercing portion of the cutting system into the object to retain the object on the piercing portion. And, the user may selectively displace the cutting portion to deform the cutting portion around the object to cut the object while the object is retained by the piercing portion.

By virtue of having cutting portions selectively arrangeable around objects to cut objects retained by a piercing portion, cutting systems according to this disclosure are adaptable to take less time to cut an object and prevent portions of a body of a user from coming in contact with a blade. For example, selectively displacing a cutting portion to deform the cutting portion around the object to cut the object takes less time than cutting the object with a blade of a knife because a user does not have to take the time to properly grip the knife and properly grip the object to prevent a blade from coming in contact with a portion of a body of the user. And, because the cutting portion deforms around the object to cut the object, a portion of a body of the user is not susceptible to a blade of a knife. For example, because cutting systems according to this disclosure comprise a cutting portion that is deformable (e.g., elastic, flexible, bendable, pliable, malleable, etc.) and not a rigid flat cutting edge of a blade, if a portion of a body of a user does come in contact with the cutting portion, the cutting portion simply deforms around the portion of the body of the user rather than slicing the portion of the body of the user.

Generally, a cutting system according to this disclosure comprises deformable cutting portions selectively arrangeable around objects to cut objects retained by a piercing portion. The cutting portion may comprise a wire, a cable, a chain, etc. that is deformable (e.g., elastic, flexible, bendable, pliable, malleable, etc.). For example, the cutting portion may comprise one or more metal wires, diamond wires, composite wires, fabric wires, etc. that are deformable and selectively arrangeable around objects to cut objects.

While the cutting systems are described in various embodiments herein as being used in the food processing industry, food cooking industry (e.g., culinary industry), restaurant industry, and/or kitchenware industry, the cutting systems may be used in the manufacturing industry, medical industry, hobby industry, gardening industry, or the like.

In addition, while the cutting system is described throughout the application as having a gripping portion (e.g., a handle) having an elongated cylindrical shape, other types of shapes are also contemplated, such as, for example, elongated oval shape, elongated rectangle shape, elongated triangle shape, spherical shaped, ellipsoid shaped, etc.

Further, while the objects are illustrated in various embodiments herein as having a spherical shape, the objects may have ellipsoid shape (e.g., an oblate spheroid shape or a prolate spheroid shape), pear-shape, clavate shape, rhomboidal shape, rectangular shape, triangular shape, etc. Moreover, while the objects are illustrated in various embodiments herein as having a size of at least about 3 inches wide to at most about 6 inches wide, the objects may have smaller or larger widths.

In one example, the cutting system may include one or more brackets configured to support (e.g., brace, bear, hold, etc.) an object when the object is retained on the piercing portion. In another example, the cutting system may include one or more receptacles (e.g., cups, containers, vessels, etc.) to contain one or more portions of the object cut from the object retained on the piercing portion.

In another example, the cutting system may comprise a bumper configured to absorb an impact of a collision of the cutting tool to dislodge a remnant portion of the object retained on the piercing portion. In another example, the cutting system may comprise a blade arranged with the gripping portion for slicing and/or scooping a portion of the object. In the example where the cutting system comprises a blade, the blade may be selectively moveable between a use position and a stowed position. When the blade is in the use position the blade extends a distance past the gripping portion and when the blade is in the stowed position the blade is arranged adjacent to the gripping portion or contained in the gripping portion.

In another example, the cutting system may comprise a mechanism arranged to retract the cutting portion into the gripping portion. In another example, the cutting system may comprise a piercing portion that is selectively moveable between a use position and a stowed position. When the piercing portion is in the use position the piercing portion extends a distance past the gripping portion and when the piercing portion is in the stowed position the piercing portion is arranged adjacent to the gripping portion or contained in the gripping portion.

Illustrative Cutting Systems with Deformable Cutting Portions

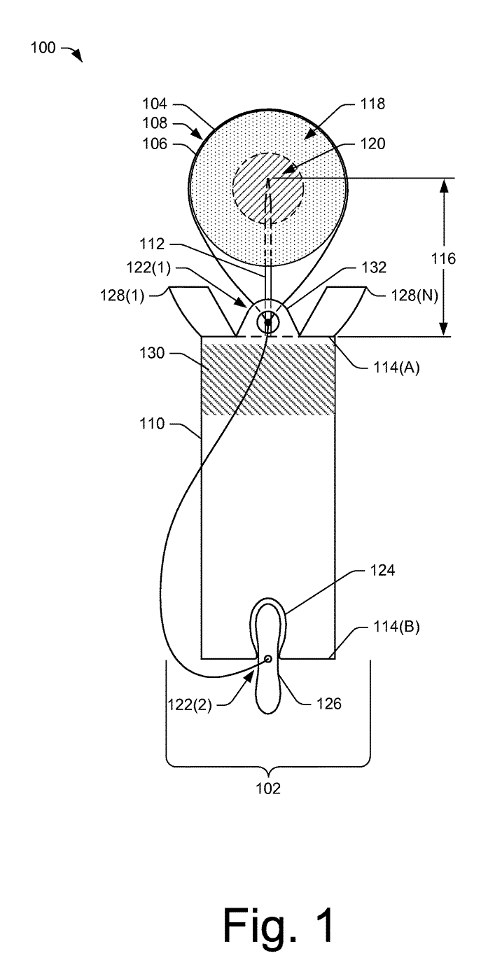

FIG. 1 depicts a front view 100 of an illustrative cutting tool 102 having a cutting portion 104 arrangeable around an exterior area 106 of an object 108 to cut the object 108. The cutting portion 104 may comprise a wire (e.g., a diamond wire, a composite wire, a fabric wire, etc.) that is deformable and selectively moveable around the exterior area 106 of an object 108 to cut the object 108. In one example, a user may pull the cutting portion 104 around the exterior area 106 of the object 108 and the cutting portion 104 may deform to the exterior area 106 of the object as the cutting portion 104 is pulled around the object 108. Stated otherwise, a user may wrap the cutting portion 104 around the exterior area 106 of the object 108 and the cutting portion 104 may deform to the exterior area 106 of the object as the cutting portion 104 is wrapped around the object 108.

The cutting tool 102 may comprise a gripping portion 110. The gripping portion 110 may be a rigid handle formed of metal, wood, composite, plastic (e.g., polypropylene (PP), acrylonitrile butadiene styrene (ABS), Polyoxymethylene (POM)), glass, any other suitable material, and/or combination of suitable materials for forming a gripping portion. The gripping portion 110 may comprise a size suitable for a hand of a user to grip. For example, the gripping portion 110 may have an outside diameter of at least about ½ inches to at most about 4 inches. In various examples, the gripping portion 110 may have an outside diameter of about 1 inch, 1.5 inches, 2 inches, 2.5 inches 3 inches etc. The gripping portion 110 may have a length of about at least about 2 inches to at most about 10 inches. In one example, the gripping portion 110 may have a length of about 5 inches. The gripping portion 110 may have an ergonomic shape. For example, the gripping portion 110 may have ridges, bands, bumps, pockets, cavities, etc. that interface with portions (e.g., thumb, fingers, palm, etc.) of a user's hand.

A piercing portion 112 may be arranged with the gripping portion 110. For example, the piercing portion 112 may be fixed to an end 114(A) of the gripping portion 110 opposite to another end 114(B) of the gripping portion 110. In one example, the piercing portion 112 may extend a distance 116 of at least about ½ inches to at most about 4 inches past the end 114(A) of the gripping portion 110. In another example, the piercing portion 112 may extend a distance 116 of at least about ½ inches to at most about 24 inches.

In one example, the piercing portion 112 may be threadably fastened to the end 114(A) of the gripping portion 110. In another example, the piercing portion 112 may be adhesively fastened to the end 114(A) of the gripping portion 110. In another example, the piercing portion 112 may be formed integrally with the end 114(A) of the gripping portion 110. In the example where the piercing portion 112 is formed integrally with the end 114(A) of the gripping portion 110, the piercing portion 112 may be formed of the same material forming the gripping portion 110. For example, the piercing portion 112 and the gripping portion 110 may be formed of a single unit of plastic, metal, wood, composite etc.

In another example, the piercing portion 112 may be selectively moveable between a use position and a stowed position. For example, the piercing portion 112 may be hingeably coupled to the end 114(A) of the gripping portion 110 and arranged to pivot about the hinge between the use position and the stowed position. For example, the piercing portion 112 may be folded about the hinge between the use position and the stowed position. When the piercing portion 112 is in the use position the piercing portion 112 extends the distance 116 past the gripping portion 110 and when the piercing portion 112 is in the stowed position the piercing portion 112 is arranged adjacent to the gripping portion 110 or contained in the gripping portion 110.

In another example, the piercing portion 112 may be slideably coupled to the end 114(A) of the gripping portion 110. For example, the piercing portion 112 may be linearly displaced between the use position and the stowed position. In the example where the piercing portion 112 is slideably coupled to the end 114(A) of the gripping portion 110, the piercing portion 112 may be linearly displaced via a spring, a lever, a motor, etc. arranged in the gripping portion 110, for example.

The piercing portion 112 may be configured for piercing the object 108 and retaining the object 108. In one example, the piercing portion 112 may be configured to pierce a softer portion 118 and a harder portion 120 and to lodge (e.g., firmly fix or embed) into the harder portion 120 to retain the object 108.

In the example where the piercing portion 112 is configured to pierce a softer portion 118 and a harder portion 120 of the object 108, the cutting portion 104 may be configured to cut the softer portion 118 of the object 108 and not the harder portion 120 of the object 108. For example, the cutting portion 104 may be a wire capable of cutting the softer portion 118 but not capable of cutting the harder portion 120. Subsequent to cutting the object 108, a remnant (e.g., harder portion 120) of the cut object may be selectively dislodged from the piercing portion 112.

In an embodiment where the piercing portion 112 is slideably coupled to gripping portion 110, the piercing portion 112 may be arranged to selectively dislodge the object 108 or the remnant (e.g., harder portion 120) of the object 108 when the piercing portion 112 is selectively displaced from the use position to the stowed position. For example, subsequent to cutting the softer portion 118 of the object 108, the harder portion 120 of the object 108 may still be retained by the piercing portion 112 and a user may selectively displace the piercing portion 112 to the stowed position to dislodge the harder portion 120 from the piercing portion 112.

In another example, the object may comprise a fruit (e.g., an avocado, a mango, a peach, an apricot, a plumb, a cherry, a nectarine, etc.) comprising a pericarp portion (e.g., softer portion 118) encapsulating a seed portion (e.g., harder portion 120). In the example where the object comprises a fruit, the piercing portion may pierce the pericarp portion and the seed portion of the fruit and lodge into the seed portion to retain the fruit on the piercing portion, and the cutting portion cuts the pericarp portion but does not cut the seed portion.

FIG. 1 illustrates the cutting portion 104 may comprise a first end 122(1) opposite a second end 122(2). In one example, the first end 122(1) may be coupled to the piercing portion 112. In another example, the first end 122(1) may be coupled to the gripping portion 110.

In some embodiments, the gripping portion 110 of the cutting tool 102 may comprise a first gripping portion (e.g., first handle) and the second end 122(2) of the cutting portion 104 of the cutting tool 102 may comprise a second gripping portion 126 (e.g., a second handle). A user may grip the first gripping portion with one hand and grip the second gripping portion with the other hand.

In some embodiments the second end 122(2) of the cutting portion 104 may be removeably received by a receptacle 124 arranged in the gripping portion 110. For example, a user may arrange the second gripping portion 126 of the cutting portion 104 in the receptacle 124 to store the cutting portion 104 until a time of use. While FIG. 1 illustrates the second gripping portion 126 of the cutting portion 104 comprising a handle for a user to grasp, the second gripping portion 126 may comprise a strap, a loop, a knob, etc. for a user to grasp.

FIG. 1 illustrates the cutting tool 102 may comprise one or more brackets 128(1) and 128(N) arranged with the gripping portion 110 proximate to the interface of the gripping portion 110 and the piercing portion 112. For example, the one or more brackets 128(1) and 128(N) may be fixed to the end 114(A) of the gripping portion 110. In one example, the one or more brackets 128(1) and 128(N) may be threadably fastened to the end 114(A) of the gripping portion 110. In another example, the one or more brackets 128(1) and 128(N) may be adhesively fastened to the end 114(A) of the gripping portion 110. In another example, the one or more brackets 128(1) and 128(N) may be formed integrally with the end 114(A) of the gripping portion 110. In the example where the one or more brackets 128(1) and 128(N) are formed integrally with the end 114(A) of the gripping portion 110, the one or more brackets 128(1) and 128(N) may be formed of the same material forming the gripping portion 110. For example, the one or more brackets 128(1) and 128(N) and the gripping portion 110 may be formed of a single unit of plastic, metal, wood, composite etc.

The one or more brackets 128(1) and 128(N) may be configured to support the object 108 when the object 108 is retained on the piercing portion 112. For example, when the object 108 is retained on the piercing portion 112, at least a portion of the exterior area 106 of the object 108 may interface with the one or more brackets 128(1) and 128(N) to hold the object 108.

FIG. 1 illustrates the cutting tool may comprise a bumper 130 arranged with the gripping portion 110 proximate to the interface of the gripping portion 110 and the piercing portion 112. For example, the bumper 130 may be arranged with the gripping portion 110 proximate to the end 114(1) of the gripping portion 110. In one example, the bumper 130 may be a separate single unit of material softer than the material forming the gripping portion 110. For example, the bumper 130 may comprise a band of rubber, cloth, composite, etc. positioned proximate to the end 114(1) of the gripping portion 110.

In another example, the bumper 130 may comprise a single unit of material formed integral with the gripping portion 110. For example, the bumper may be a band, strip, pad, etc. of plastic fixed in the gripping portion 110 proximate to the end 114(1) of the gripping portion 110. For example, the bumper 130 may be a band of plastic overmolded, threaded, press-fit, snap-fit, adhered, etc., to the gripping portion 110 proximate to the end 114(1) of the gripping portion. The bumper 130 may be configured to absorb an impact of a collision of the cutting tool 102 to dislodge a remnant portion (e.g., harder portion 120) of the object 108 retained on the piercing portion 112. For example, the bumper 130 may provide for absorbing an impact of a collision between the gripping portion 110 and a receptacle (e.g., a can, a box, a bucket, a bowl) to selectively dislodge the harder portion 120 of the object 108 retained on the piercing portion 112 into the receptacle.

A guide member 132 may arranged with the gripping portion 110 proximate to the end 114(1) of the gripping portion 110 to guide the cutting portion 104. The guide member 132 may slideably receive the cutting portion 104 to guide the cutting portion 104 when a user displaces the cutting portion 104.

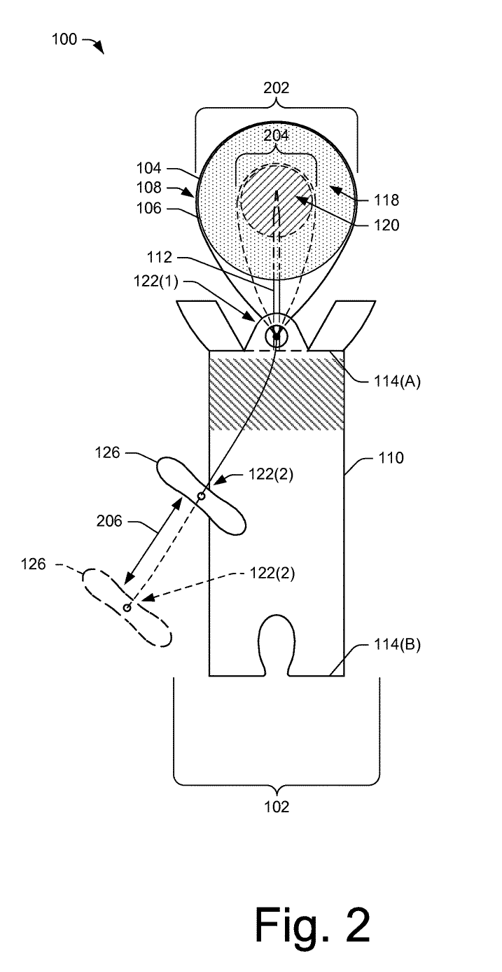

FIG. 2 illustrates the cutting portion 104 may be configured to deform from a first shape 202 to a second shape 204 to cut the object 108. For example, the cutting portion 104 may be configured to deform from the first shape 202 having a size substantially the same as a size of the exterior area 106 of the object 108 to the second shape 204 having a size smaller than the size of the exterior area 106 of the object 108. Deforming the cutting portion 104 from the first shape 202 to the second shape 204 may provide for cutting the object 108 from the exterior area 106 of the object 108 in towards the interior of the object 108. For example, when the second end 122(2) of the cutting portion 104 is displaced a distance 206 the cutting portion 104 may deform from the first shape 202 around the object 108 to the second shape 204 to cut the object. In this way, the cutting portion 104 cuts the object 108 while the piercing portion 112 retains the object 108. While FIG. 2 illustrates the second shape 204 of the cutting portion 104 deformed around the harder portion 120 of the object 108, the second shape 204 of the cutting portion 104 may not be deformed around the harder portion 120 of the object 108. For example, the object may not have a harder portion and the cutting portion may deform from the first shape around the object to a second shape having a size smaller than the size of the exterior area of the object. For example, the cutting portion may deform from the first shape to the second shape while the cutting portion is displaced substantially all the way through the object.

In the embodiment where the object 108 comprises the softer portion 118 encapsulating the harder portion 120, the cutting portion 104 may be configured to cut the softer portion 118 when the cutting portion 104 is deformed from the first shape 202 to the second shape 204. In one example, the cutting portion 104 may deform around the outside surface of the harder portion 120 and not cut into the harder portion 120. In another example, the cutting portion 104 may deform around the outside surface of the harder portion 120 and slideably displace along the outside surface of the harder portion 120.

In the embodiment where the object 108 comprises a fruit comprising a pericarp portion (e.g., softer portion 118) encapsulating a seed portion (e.g., harder portion 120), the cutting portion 104 may be configured to cut the pericarp portion when the cutting portion 104 is deformed from the first shape 202 to the second shape 204. In one example, the cutting portion 104 may deform around the outside surface of the seed portion and not cut into the seed portion. In another example, the cutting portion 104 may deform around the outside surface of the seed and slideably displace along the outside surface of seed.

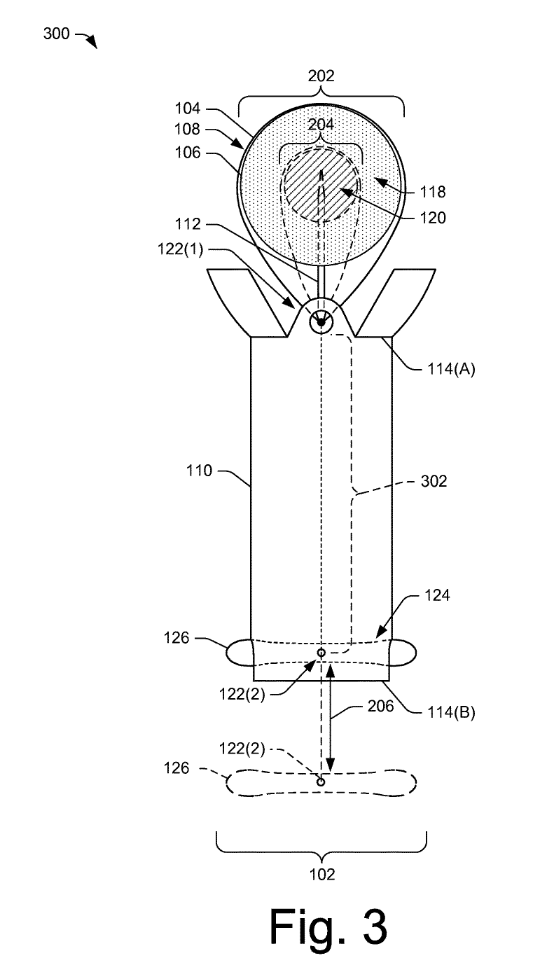

FIG. 3 depicts a front view 300 of an alternative implementation of the cutting tool 102 having the cutting portion 104 arrangeable around an exterior area of the object 108 to cut the object 108. FIG. 3 illustrates the alternative implementation of the cutting tool 102 may have at least a section 302 of the cutting portion 104 arranged in the gripping portion 110 of the cutting tool 102. In this alternative implementation of the cutting tool 102 when the cutting portion 104 is displaced a distance 206, the section 302 of the cutting portion 104 is displaced in the gripping portion 110. For example, when the cutting portion 104 deforms from the first shape 202 to the second shape 204, the second end 122(2) of the cutting portion 104 is displaced a distance 206, the section 302 of the cutting portion 104 may be displaced through the gripping portion 110.

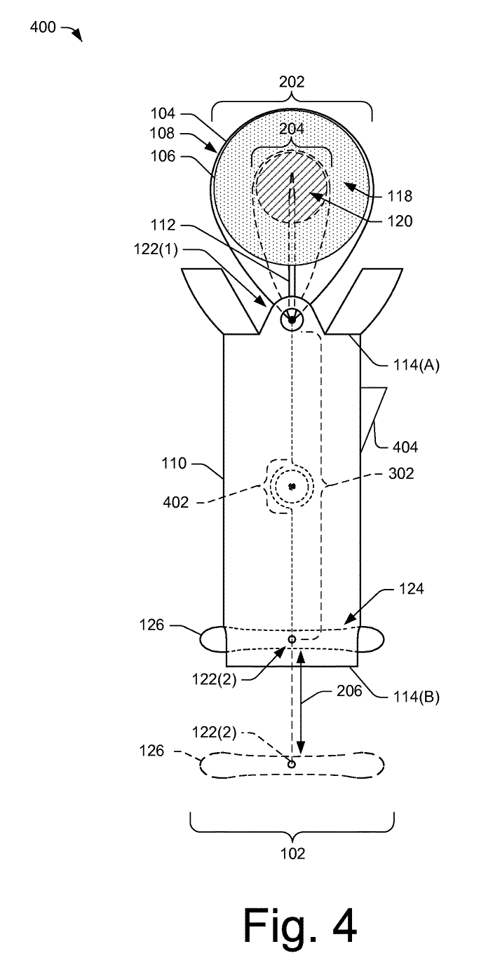

FIG. 4 depicts a front view 400 of an alternative implementation of the cutting tool 102 having the cutting portion 104 arrangeable around an exterior area 106 of the object 108 to cut the object 108. FIG. 4 illustrates that the alternative implementation of the cutting tool 102 may have a mechanism 402 arranged with the section 302 of the cutting portion 104 in the gripping portion 110 of the cutting tool 102. The mechanism 402 arranged in the gripping portion 110 may comprise a rewind mechanism arranged to rewind the section 302 of the cutting portion 104. For example, after the second end 122(2) of the cutting portion 104 is displaced a distance 206, the mechanism 402 may rewind the section 302 of the cutting portion 104 back in the gripping portion 110. In some embodiments the mechanism 402 may automatically (without user involvement) rewind the section 302 of the cutting portion 104 back in the gripping portion 110. In other embodiments the mechanism 402 may selectively rewind the section 302 of the cutting portion 104 back in the gripping portion 110. In embodiments where the mechanism 402 selectively rewinds the section 302 of the cutting portion 104 back in the gripping portion 110, a user may selectively activate the mechanism 402 to rewind the section 302 such as via a trigger 404 arranged with the gripping portion 110. In some embodiments, the mechanism 402 may selectively displace the cutting portion 104 from the first position 202 to the second position 204 to cut the object 108. For example, a user may selectively activate the mechanism 402 via the trigger 404 arranged with the gripping portion 110 to selectively displace the cutting portion 104 arranged around the object 108 from the first position 202 to the second position 204 to cut the object 108.

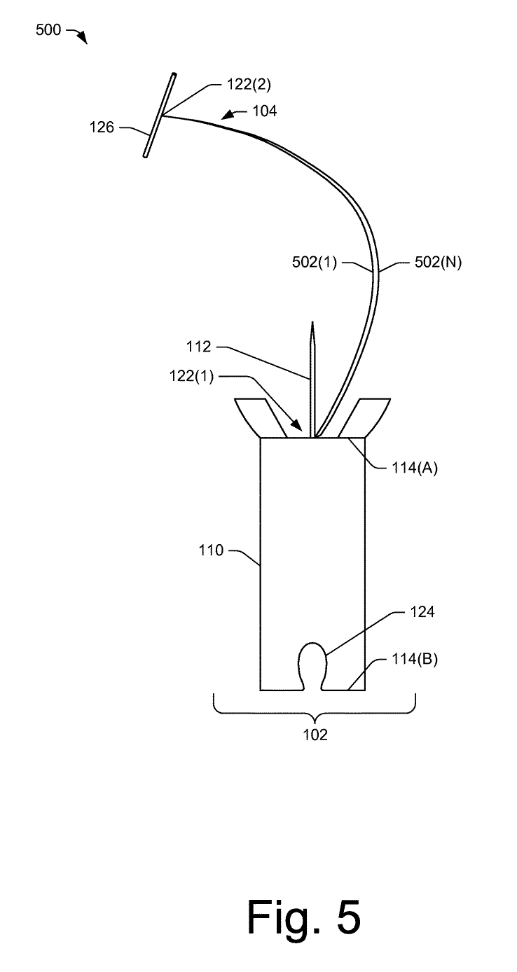

FIG. 5 depicts a front view 500 of another alternative implementation of the cutting tool 102 having the cutting portion 104 arrangeable around an exterior area of an object to cut the object. FIG. 5 illustrates the alternative implementation of the cutting tool 102 may comprise two or more members 502(1) and 502(N) forming the cutting portion 104. For example, the cutting portion 104 may comprise at least two wires that are deformable and selectively moveable around the exterior area 106 of an object 108 to cut the object 108. In one example, the cutting portion 104 comprising two or more members 502(1) and 502(N) may be for cutting around the harder portion 120 of the object 108 having a rough (e.g., corrugated) surface. Stated otherwise, the first and second members 502(1) and 502(N) may deform together from the first shape 202 to the second shape 204 and cut around the harder portion 120 of the object 108 having a rough (e.g., corrugated) surface. The first member 502(1) may cut along a first portion of the corrugated surface while the second member 502(2) may track or trail behind the first member 502(1) and cut along a second portion of the corrugated surface that the first member 502(1) did not cut. In the example where the object 108 may comprise a fruit, the fruit may comprise a peach having a seed portion with the corrugated surface. In this example, where the object 108 comprises a peach having a seed portion with a corrugated surface, the first member 502(1) may cut along a first portion of the corrugated surface of the seed portion while the second member 502(N) may track behind the first member 502(N) and cut along a second portion of the corrugated surface of the seed portion to cut the pericarp portion (e.g., softer portion 118) encapsulating the seed portion having the corrugated surface.

The two or more members 502(1) and 502(N) forming the cutting portion 104 may each comprise a wire, a cable, a chain, etc. that is deformable (e.g., elastic, flexible, bendable, pliable, malleable, etc.). For example, the two or members 502(1) and/or 502(N) may comprise a metal wire, a diamond wire, a composite wire, a fabric wire, etc. that is deformable and selectively arrangeable around objects to cut objects.

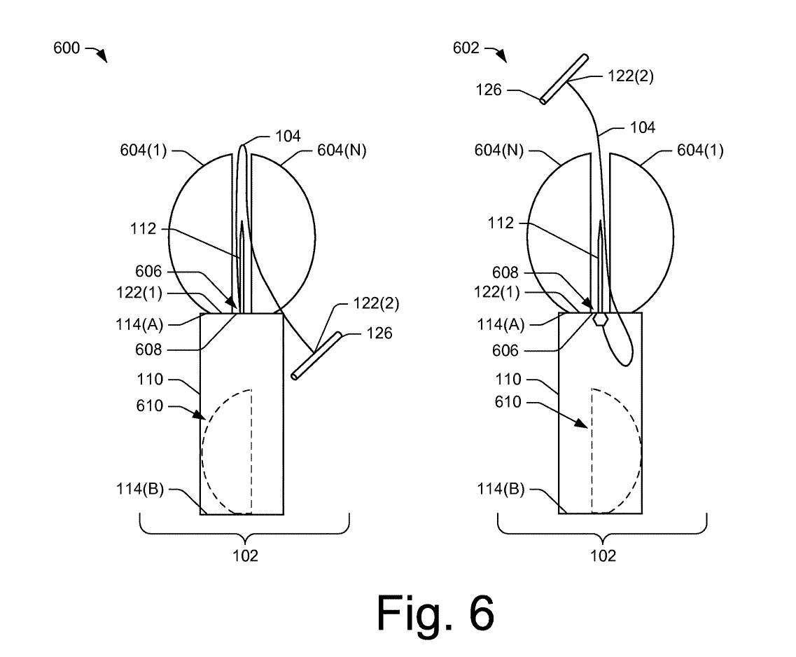

FIG. 6 depicts a front view 600 and a back view 602 of another alternative implementation of the cutting tool 102 having the cutting portion 104 arrangeable around an exterior area of an object to cut the object. FIG. 6 illustrates the alternative implementation of the cutting tool 102 may comprise one or more receptacles 604(1) and 604(N) arranged with the gripping portion 110 proximate to the interface of the gripping portion 110 and the piercing portion 112. For example, the one or more receptacles 604(1) and 604(N) may be pivotably coupled to the end 114(A) of the gripping portion 110 and proximate to the piercing portion 112. The one or more receptacles 604(1) and 604(N) may be selectively displaced between an open position and a closed position. When in the open position the one or more receptacles 604(1) and 604(N) may be arranged at an obtuse angle relative to one another to provide for the piercing portion 112 to pierce an object and/or to remove a cut portion of the object. When in the closed position the one or more receptacles 604(1) and 604(N) may be arranged at an acute angle relative to one another to provide for containing the object. Further, when in the closed position the one or more receptacles 604(1) and 604(N) may be configured to support the object when the object is retained on the piercing portion 112. For example, when the object is retained on the piercing portion 112, at least a portion of the exterior area of the object may interface with the one or more receptacles 604(1) and 604(N) to hold the object while the cutting portion 104 cuts the object 108.

The one or more receptacles 604(1) and 604(N) may be configured to contain one or more portions of the object cut from the object retained on the piercing portion 112. For example, the one or more receptacles 604(1) and 604(N) may be configured to contain first and second halves of the softer portion 118 of the object 108 cut from the harder portion 120 of the object 108 retained on the piercing portion 112.

The front view 600 of the alternative implementation of the cutting tool 102 illustrates the cutting portion 104 may be fixed to a back portion 606 of the end 114(A) of the gripping portion 110 and arrangeable around an exterior area of the object retained by the piercing portion 112 to cut the object. For example, a user may pull the cutting portion 104 from the back portion 606 of the gripping portion 110 toward a front portion 608 of the end 114(A) of the gripping portion 110 to arrange the cutting portion 104 around the exterior area 106 of the object 108 to cut the object 108. The back view 602 of the alternative implementation of the cutting tool 102 illustrates the first end 122(1) of cutting portion 104 may be fixed to the end 114(A) of the gripping portion 110 between the one or more receptacles 604(1) and 604(N).

The front view 600 and the back view 602 illustrate the alternative implementation of the cutting tool 102 may include a blade 610 arranged with the gripping portion 110 opposite the piercing portion 112. For example, the cutting tool 102 may include a blade pivotably coupled to the other end 114(B) of the gripping portion 110 and arranged to be selectively pivoted between a stowed position and a use position. For example, the blade 610 may be selectively pivoted from a stowed position where the blade is contained in the gripping portion 110 to a use position where the blade is exposed and extends a distance past the gripping portion 110. The blade 610 may be configured for slicing or scooping a portion of the object 108. For example, the blade 610 may be configured for slicing or scooping the softer portion 118 of the object 108 subsequent to the cutting of the object 108. While FIG. 6 illustrates the blade 610 contained in the gripping portion 110 when in the stowed position, the blade 610 may be arranged adjacent to the gripping portion 110 when in the stowed position. Further, the blade 610 can be included in other implementations of the cutting tool 102.

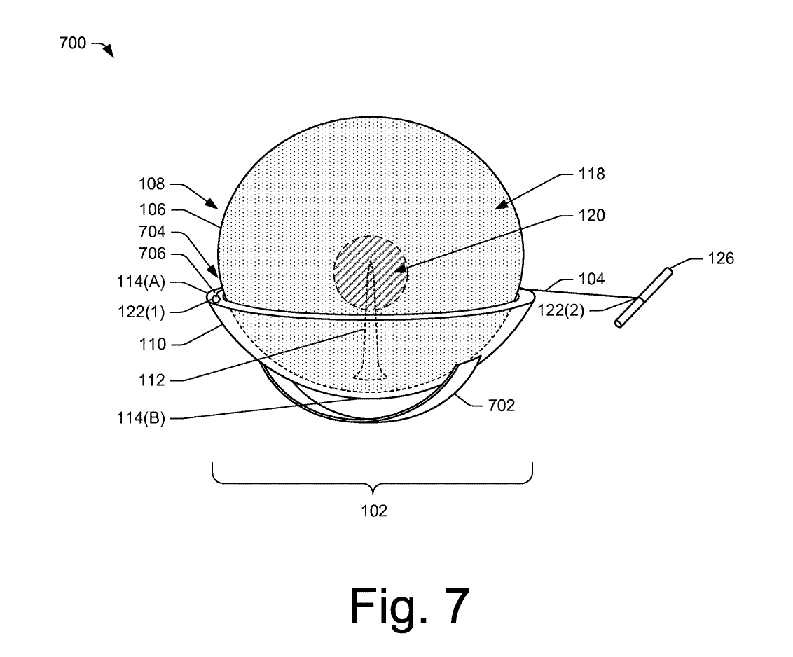

FIG. 7 illustrates a perspective view 700 of another alternative implementation of the cutting tool 102 having the cutting portion 104 arrangeable around and the exterior of the object. FIG. 7 illustrates that the alternative implementation of the cutting tool 102 may comprise a strap 702. For example, the gripping portion 110 may comprise a receptacle 704 arranged between the end 114(A) and the other end 114(B) of the gripping portion 110 and a strap 702 coupled to the gripping portion 110. The strap 702 may provide for a hand of a user to grasp the gripping portion 110. For example, a palm aspect of a hand of the user may grasp the gripping portion 110 while the strap 702 interfaces with the dorsal aspect of the hand of the user.

The perspective view 700 of the alternative implementation of the cutting tool 102 illustrates the first end 122(1) of the cutting portion 104 may be fixed to a top portion 706 of the receptacle 704. For example, the first end 122(1) of the cutting portion 104 may be fixed to a rim (e.g., lip) of the receptacle 704. The cutting portion 104 may be arrangeable along the top portion 706 of the receptacle 704 and arrangeable around the exterior area 106 of the object 108 to cut the object 108.

Example Method of Cutting an Object with a Cutting Tool Having a Cutting Portion Arrangeable Around an Exterior of the Object

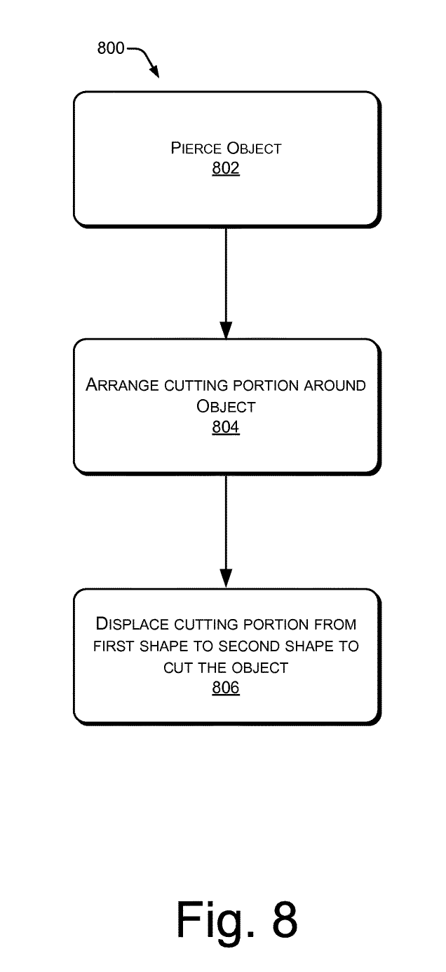

FIG. 8 illustrates an example process 800 of cutting an object (e.g., object 108) with a cutting tool (e.g., cutting tool 102) having a cutting portion 104 arrangeable around an exterior area (e.g., exterior area 106) of the object. By way of example and not limitation, this process may be performed at a food processing facility, a food cooking facility (e.g., restaurant), a kitchen facility, manufacturing facility, medical facility, hobby facility, gardening facility, or the like.

Process 800 includes operation 802, which may represent piercing the object with a piercing portion (e.g., piercing portion 112) to retain the object on the piercing portion. For example, a user may grip the gripping portion and force the piercing portion into the object to pierce a softer portion (e.g., softer portion 118) encapsulating a harder portion (e.g., harder portion 120) of the object to retain the object on the piercing portion.

Process 800 may include operation 804, which represents arranging the cutting portion, coupled with the piercing portion, around the exterior area of the object to cut the object.

Process 800 may be completed at operation 806, which may represent displacing the cutting portion and deforming the cutting portion from a first shape (e.g., first shape 202) having a size substantially the same as a size of the exterior of the object to a second shape (e.g., second shape 204) having a size smaller than the size of the exterior of the object to cut the object from the exterior of the object in towards an interior of the object. For example, a user may pull the cutting portion a distance (e.g., distance 206) to deform the cutting portion 104 from the first shape to the second shape to cut the object from the exterior of the object in towards the interior of the object.

In the embodiment where the object 108 comprises the softer portion encapsulating the harder portion, the piercing portion pierces the softer portion and the harder portion and lodges into the harder portion to retain the object on the piercing portion. Further, the cutting portion may be configured to cut the softer portion when the cutting portion is deformed from the first shape to the second shape. In one example, the cutting portion may deform around the outside surface of the harder portion and not cut into the harder portion. In another example, the cutting portion may deform around the outside surface of the harder portion and slideably displace along the outside surface of the harder portion.

In embodiments where the object comprises a fruit comprising a pericarp portion (e.g., softer portion 118) encapsulating a seed portion (e.g., harder portion 120), the piercing portion pierces the pericarp portion and the seed portion and lodges into the seed portion to retain the fruit on the piercing portion. Further, the cutting portion may be configured to cut the pericarp portion when the cutting portion is deformed from the first shape to the second shape. In one example, the cutting portion may deform around the outside surface of the seed portion and not cut down into the seed portion. In another example, the cutting portion may deform around the outside surface of the seed and slideably displace along the outside surface of seed.

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. For example, in various embodiments, any of the structural features and/or methodological acts described herein may be rearranged, modified, or omitted entirely. For example, the shape, size, and configuration of the gripping portion and cutting portion may be varied.

What is claimed is:

1. A cutting tool comprising:
a gripping portion;
a piercing portion arranged with the gripping portion, the piercing portion configured for piercing an object and retaining the object; and
a cutting portion coupled to the gripping portion or the piercing portion, the cutting portion arrangeable around an exterior area of the object to cut the object while the object is pierced by the piercing portion.

2. The cutting tool of claim 1, wherein the cutting portion comprises a first end coupled to the gripping portion or the piercing portion and a second end opposite the first end, the gripping portion comprising a first gripping portion and the second end of the cutting portion comprising a second gripping portion, and
wherein the cutting portion is configured to deform from a first shape having a size substantially the same as a size of the exterior of the object to a second shape having a size smaller than the size of the exterior of the object to cut the object from the exterior of the object in towards an interior of the object when the second gripping portion is displaced.

3. The cutting tool of claim 1, wherein the cutting portion comprises a wire or a cable.

4. The cutting tool of claim 1, wherein the gripping portion comprises at least a handle or a strap.

5. The cutting tool of claim 1, wherein:
the piercing portion is configured to pierce a softer portion and a harder portion of the object and to lodge into the harder portion to retain the object; and
the cutting portion is configured to cut the softer portion.

6. The cutting tool of claim 1, wherein when the object comprises a fruit comprising a pericarp portion encapsulating a seed portion:
the piercing portion is configured to pierce the pericarp portion and the seed portion of the fruit and to lodge into the seed to retain the fruit; and
the cutting portion is configured to cut the pericarp portion encapsulating the seed portion.

7. A cutting tool comprising:
a gripping portion;
a pick coupled to the gripping portion, the pick configured for piercing an object and retaining the object; and
a cutting member arranged proximate to an interface of the gripping portion and the pick, the cutting member configured to be selectively moveable to deform the cutting member around an exterior area of the object to cut the object.

8. The cutting tool of claim 7, wherein when the object comprises a softer portion encapsulating a harder portion:
the pick is configured to pierce the softer portion and the harder portion and to lodge into the harder portion to retain the object; and
the cutting member is configured to cut the softer portion.

9. The cutting tool of claim 7, wherein when the object comprises a fruit comprising a pericarp portion encapsulating a seed portion:
the pick pierces the pericarp portion and the seed portion of the fruit and lodges into the seed to retain the fruit; and
the cutting member cuts the pericarp portion.

10. The cutting tool of claim 7, wherein the cutting member comprises a wire or cable.

11. The cutting tool of claim 7, further comprising a mechanism arranged to retract the cutting member into the gripping portion.

12. The cutting tool of claim 7, further comprising a bumper arranged with the gripping portion proximate to the interface of the gripping portion and the pick, the bumper configured to absorb an impact of a collision of the cutting tool to dislodge a remnant portion of the object retained on the pick.

13. The cutting tool of claim 7, further comprising one or more brackets arranged with the gripping portion proximate to the interface of the gripping portion and the pick, the one or more brackets configured to support the object when the object is retained on the pick.

14. The cutting tool of claim 7, further comprising one or more receptacles arranged with the gripping portion proximate to the interface of the gripping portion and the pick, the one or more receptacles configured to contain one or more portions of the object cut from the object retained on the pick.

15. The cutting tool of claim 7, further comprising a blade arranged with the gripping portion opposite the pick, the blade configured for slicing or scooping a portion of the object.

16. The cutting tool of claim 7, wherein the pick is selectively moveable between a use position and a stowed position, and wherein when the pick is in the use position the pick extends a distance past the gripping portion and when the pick is in the stowed position the pick is arranged adjacent to the gripping portion or contained in the gripping portion.

17. A method of cutting an object comprising:
piercing the object with a pick to retain the object on the pick; and
arranging a cutting member, coupled with the pick, around an exterior area of the object to cut the object while object is pierced by the pick.

18. The method of claim 17, further comprising displacing the cutting member and deforming the cutting member from a first shape having a size substantially the same as a size of the exterior of the object to a second shape having a size smaller than the size of the exterior of the object to cut the object from the exterior of the object in towards an interior of the object.

19. The method of claim 18, wherein when the object comprises a softer portion encapsulating a harder portion:
the pick pierces the softer portion and the harder portion and lodges into the harder portion to retain the object; and
wherein displacing the cutting member from the first shape to the second shape cuts the softer portion.

20. The method of claim 18, wherein when the object comprises a fruit comprising a pericarp portion encapsulating a seed portion:
the pick pierces the pericarp portion and the seed portion and lodges into the seed portion to retain the fruit; and
wherein the displacing of the cutting member from the first shape to the second shape further comprises cutting the pericarp portion.
